(19) United States
(12) Patent Application Publication
(10) Pub. No.: US 2017/0262938 A1
(43) Pub. Date: Sep. 14, 2017

(54) Method of Managing Cargo Investments and Tracking Shipments

(71) Applicant: Nelson Etuale Sua, Detroit, MI (US)

(72) Inventor: Nelson Etuale Sua, Detroit, MI (US)

(21) Appl. No.: 15/458,762

(22) Filed: Mar. 14, 2017

Related U.S. Application Data
(60) Provisional application No. 62/307,834, filed on Mar. 14, 2016.

(51) Int. Cl. G06Q 40/06; G06Q 10/08; G06Q 20/10; G06Q 50/18

(52) U.S. Cl. CPC G06Q 40/06; G06Q 50/188; G06Q 10/0833; G06Q 20/10

(57) ABSTRACT

A method of managing cargo investments and tracking shipments is used as a means for investors to earn money from the profits of individual cargo shipments. The method is performed by a system which includes a personal computing device, at least one server and a plurality of onboard shipment computing devices. The remote server manages an investor profile and a plurality of shipment vehicle profiles. The personal computing device is linked to the investor profile and is used to send an investment contract to the remote server. The remote server assigns the investor profile to at least one investment vehicle profile which is linked to a corresponding onboard shipment computing device. The corresponding onboard shipment computing device monitors a shipment status for the investment vehicle profile. Upon receiving a shipping payment with the remote server, an investor payout is calculated and transferred to the investor profile with the remote server.

The current application claims a priority to the U.S. Provisional Patent application Ser. No. 62/307,834 filed on Mar. 14, 2016.

### FIELD OF THE INVENTION

The present invention relates generally to methods of investment. More specifically, the present invention relates to a method of investing in cargo shipments and tracking the progress of one or more shipments remotely.

### BACKGROUND OF THE INVENTION

Conventional forms of investment are widely used as a means of securing a stable financial future. While investing in the stock market is a common approach, amateur investors can easily become overwhelmed by a constantly shifting market and a need to monitor individual stocks. Further, investment firms often charge fees for each trade, which can lead to a considerable cost at the expense of the investor. To an inexperienced investor, this multitude of factors can be daunting and may even be too much to handle.

For individuals who obtain a financial loan, meeting monthly payments can be difficult to consistently meet. This may especially be the case for small businesses such as with a trucking or shipping business. Failing to meet a monthly payment can lead to late fees which put further strain on a borrower.

Accordingly, there is a present need for a means of investing in cargo shipments in order to benefit investors and borrowers alike. Further, there is a need to allow investors and borrowers to track shipments and be notified of shipment statuses either through the web or a mobile application. The present invention is a method of managing cargo investments and tracking shipments. With the method of the present invention, borrowers may use money from investors in order to pay for vehicles in a shipping fleet. In turn, investors are able to receive a portion of the profits earned from the completion of each shipment for an assigned vehicle. Investors may also choose the terms of an investment contract in order to dictate how money is made. The method of the present invention also includes a means of tracking shipments so that investors may monitor their investments.

### BRIEF DESCRIPTION OF THE DRAWINGS

FIG. 1 is a schematic diagram of the system used by the present invention.

FIG. 2 is a flowchart for the overall process of the present invention.

FIG. 3 is a flowchart describing the steps of extrapolating the investor payout using the load ticket.

FIG. 4 is a flowchart describing the steps of calculating the investor payout using a shipment weight.

FIG. 5 is a flowchart describing the steps of calculating the investor payout using a shipment distance.

FIG. 6 is a flowchart describing the steps of calculating the investor payout the shipping payment and the rate of return.

FIG. 7 is a flowchart describing the steps of generating a shipment invoice for the shipping payment.

FIG. 8 is a flowchart describing the steps of tracking the shipment location for the investment vehicle profile.

FIG. 9 is a flowchart describing the steps of displaying the shipment status with the personal computing device.

FIG. 10 is a flowchart describing the steps of compiling contract terms into the investment contract.

### DETAILED DESCRIPTION OF THE INVENTION

All illustrations of the drawings are for the purpose of describing selected versions of the present invention and are not intended to limit the scope of the present invention.

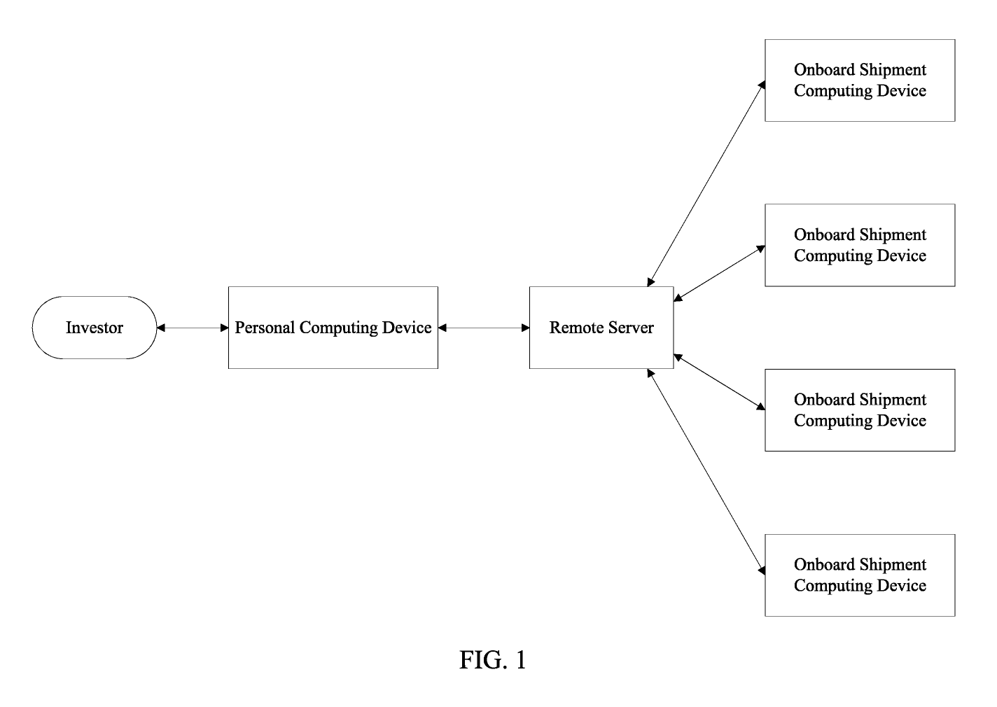

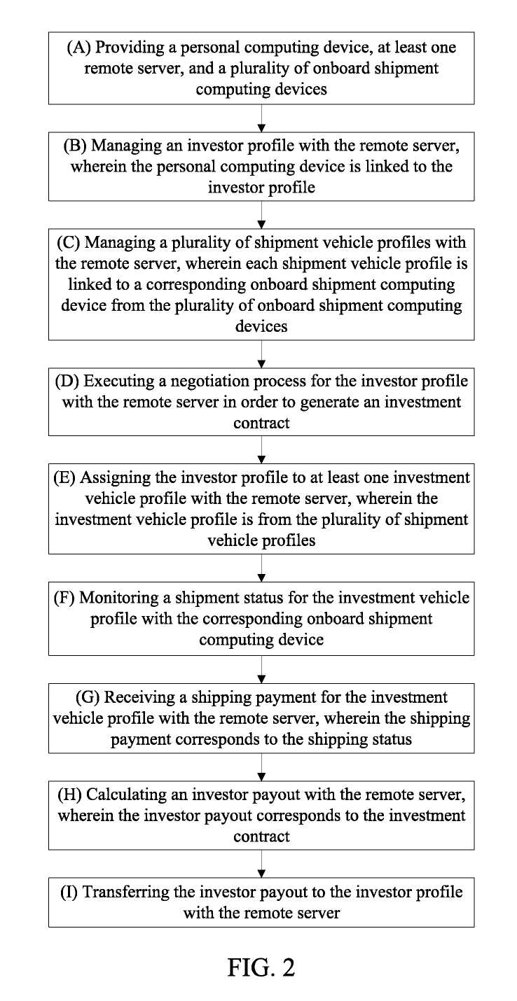

With reference to FIGS. 1-2, the present invention is a method of managing cargo investments and tracking shipments which is used to facilitate investment in the shipping industry. The method of the present invention allows investors to make simple investments that provide profitable returns in a relatively short amount of time. The present invention provides a safe means of investment and allows investors to track the progress of shipments that they are invested in. The method of the present invention is performed by a system which comprises a personal computing device, at least one remote server, and a plurality of onboard shipment computing devices (Step A). The remote server is used to manage an investor profile (Step B). The personal computing device is linked to the investor profile such that an investor may view the details of current investments or make new investments from the personal computing device. The remote server also manages a plurality of shipment vehicle profiles (Step C). Each shipment vehicle profile is linked to a corresponding onboard shipment computing device from the plurality of onboard shipment computing devices. The onboard shipment computing devices track the progress of individual shipments and may be used to record information about a shipment.

In reference to FIGS. 1-2, to initiate an investment, the remote server executes a negotiation process for the investor profile in order to generate an investment contract (Step D). The investment contract outlines the specifications of the agreement made between the investor and a borrower. The information included within the investment contract may pertain to the rate of return for an investment, the duration of the investment, and any special circumstances which may need to be accounted for. In the preferred embodiment of the present invention, the borrower uses money provided by the investor to purchase a vehicle used for making shipments. The vehicle used to make shipments, may be a truck, train, boat, or any other form of shipping vessel. The remote server assigns the investor profile to at least one investment vehicle profile, wherein the investment vehicle profile is from the plurality of shipment vehicle profiles (Step E). Depending on the size of the investment made by the investor through the investment contract, the investor may be assigned to multiple investment vehicle profiles or may expect a higher rate of return. As shipments are made, the corresponding onboard shipment computing device monitors a shipment status for the investment vehicle profile (Step F). The shipment status allows the investor to track the progress of a shipment but may also be used to calculate the value of a shipment.

In reference to FIGS. 1-2, After a shipment is delivered, the remote server receives a shipping payment for the investment vehicle profile, wherein the shipping payment corresponds to the shipping status (Step G). With the shipping payment received, the remote server calculates an investor payout with the remote server (Step H). The investor payout corresponds to the investment contract. Depending on the investment contract, the investor may be paid based on the weight of the shipment, the distance required to deliver the shipment, or various other factors. The remote server transfers the investor payout to the investor profile (Step I). Once transferred, the investor payout may be withdrawn by the investor.

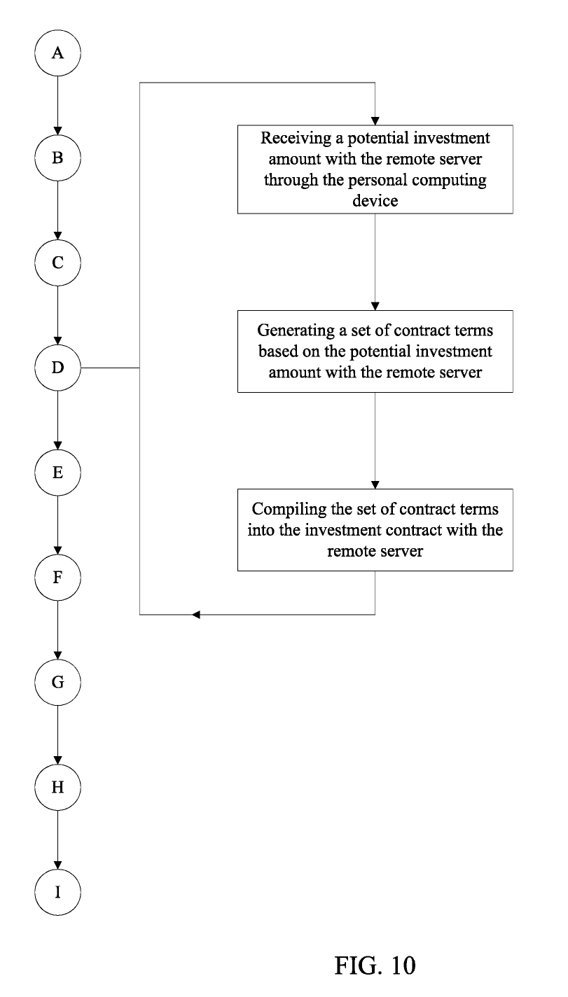

In reference to FIG. 10, the parameters of the investment contract depend on how much money the investor wishes to invest. By investing more money, the user may receive a better rate of return, receive payouts from multiple investment vehicle profiles, or receive payouts through an investment vehicle profile over a longer period of time. In order to define the parameters of the investment contract, a potential investment amount is received with the remote server through the personal computing device. The potential investment amount may be selected from a list or chart of provided packages, or may be a custom amount. The remote server generates a set of contract terms based on the potential investment amount. The investor may choose to prioritize selected terms. For example, the investor may choose to receive a lower rate of return in favor of a longer duration for the investment contract. Once the contract terms are approved by the investor, the remote server compiles the set of contract terms into the investment contract. The investor may then transfer a contract investment, which matches the potential investment amount, to the remote server.

An example of the investment contract is as follows. If one or more investors choose to invest a total of $1,000,000, the investor(s) may expect a rate of return of 8% on 11 investment vehicle profiles over a period of 5 years. The investment contract may be one of many pre-existing “packages” that are linked to varying rates of returns. If multiple investors are participating in this package, each investor may be required to invest a minimum of $1,000. Because multiple investors may not contribute the same amount as part of the contract investment, shares may be proportionately delegated by the remote server based on the contribution for each investor. Here, the shares represent a percentage of the investor payout. By investing in packages that require a greater initial investment, the investors may expect an increased the rate of return on each investment vehicle profile or may be assigned to additional investment vehicle profiles. After an investment contract expires, the investor is notified and the contract investment is returned to the investor minus any fees that may have been associated with the investment contract.

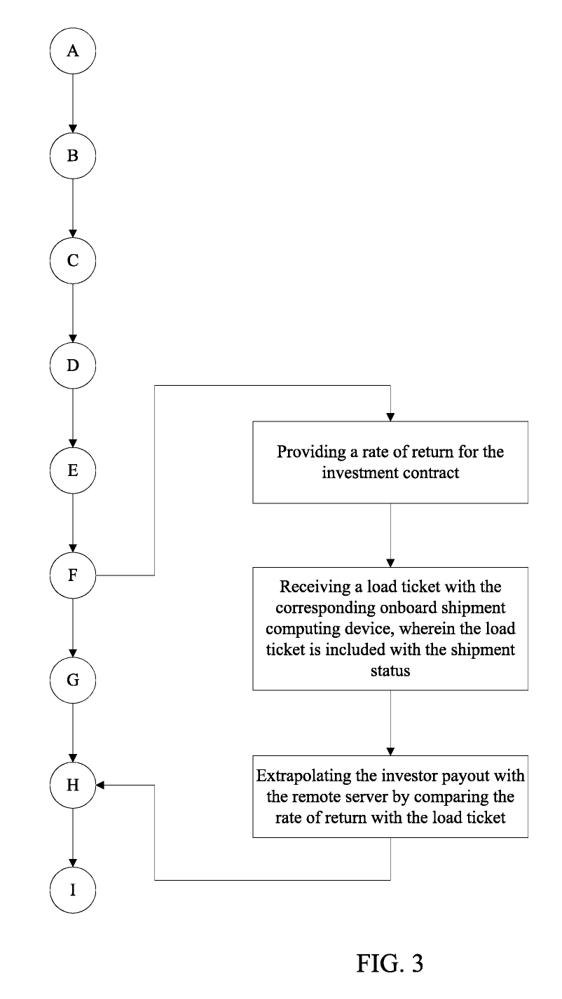

In reference to FIG. 3, the investment contract comprises a rate of return. The rate of return determines how much money the investor makes per shipment. The rate of return may depend on how much the contract investment or may simply be provided as a flat rate. In the preferred embodiment of the present invention, upon delivering a shipment, the corresponding onboard shipment computing device receives a load ticket. The load ticket is included with the shipment status and outlines details about the shipment. The remote server extrapolates the investor payout by comparing the rate of return with the load ticket.

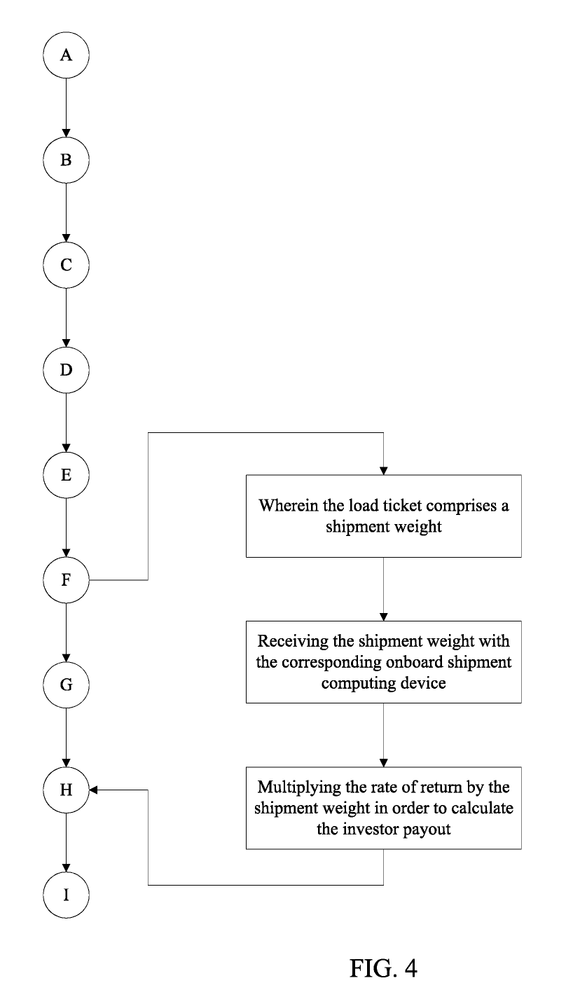

In reference to FIG. 4, one method of determining the investor payout may be based on the weight of the goods shipped. In this case, the load ticket comprises a shipment weight. The corresponding onboard shipment computing device receives the shipment weight. This may be done either through manual input or through the connection to a scale. In order to calculate the investor payout, the remote server multiplies the rate of return by the shipment weight. In this case, the rate of return is weight-based.

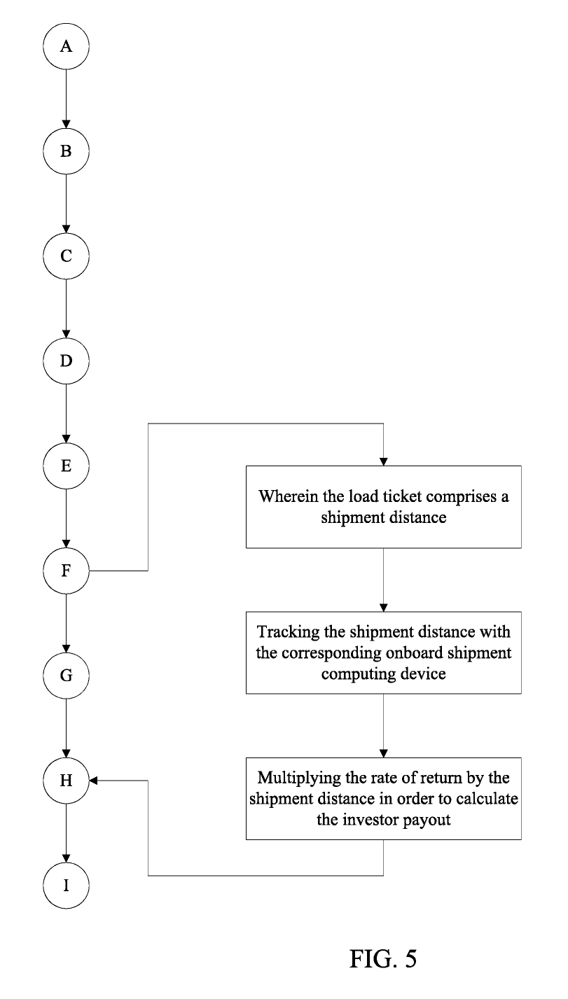

In reference to FIG. 5, another method of determining the investor payout is based on the distance traveled to complete a shipment. In this case, the load ticket comprises a shipment distance. The corresponding onboard shipment computing device tracks the shipment distance. To do this, the corresponding onboard shipment computing device makes use of a Global Positioning System (GPS). In order to calculate the investor payout, the remote server multiplies the rate of return by the shipment distance. In this case, the rate of return is distance-based.

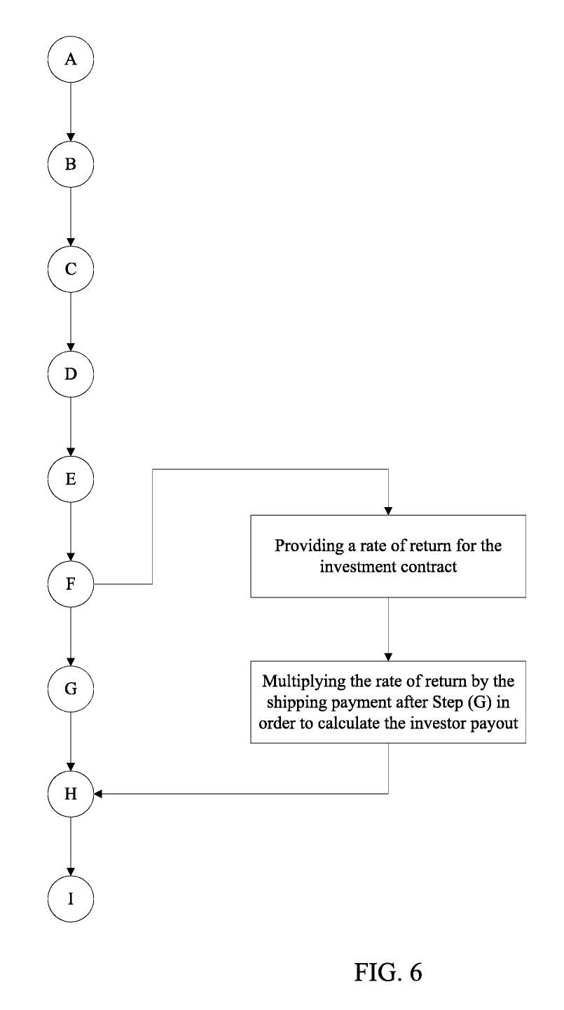

In reference to FIG. 6, instead of factoring in the weight of a shipment or the distance traveled for a shipment, the investor payout may simply be offered as a flat rate. In this case, the remote server multiplies the rate of return by the shipping payment after Step (G) in order to calculate the investor payout. This provides a much simpler means of investing and may be easily understood by amateur investors.

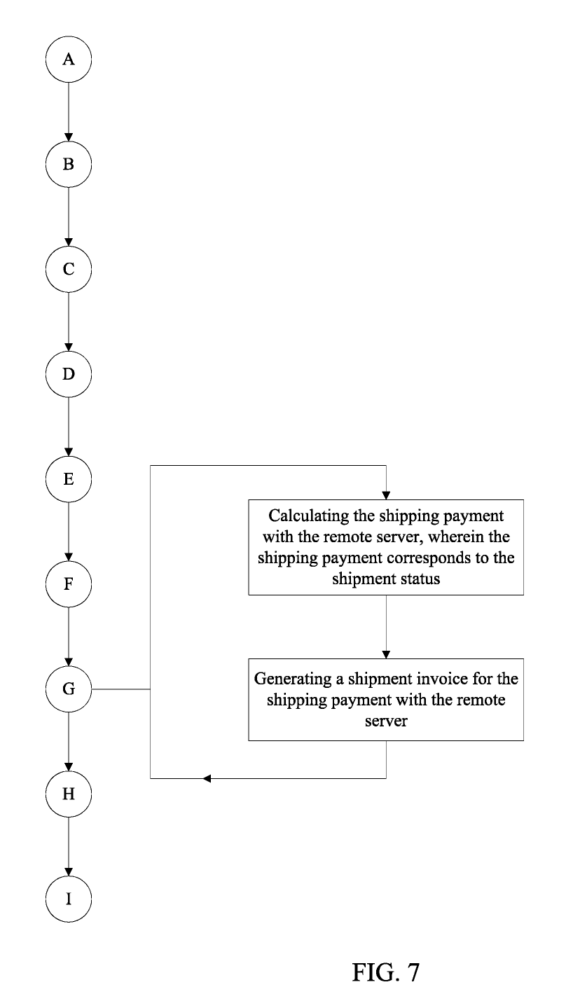

In reference to FIG. 7, depending on agreements made between the borrower and third parties requiring the shipment of goods, the remote server may be used to bill the third party for a shipment. In this case, the remote server calculates the shipping payment. The shipping payment corresponds to the shipment status and, like the investor payout, may be determined based on the weight of the goods being shipped or the distance in which goods are shipped. The remote server then generates a shipment invoice for the shipping payment. The shipment invoice is used to bill the third party once goods have been shipped.

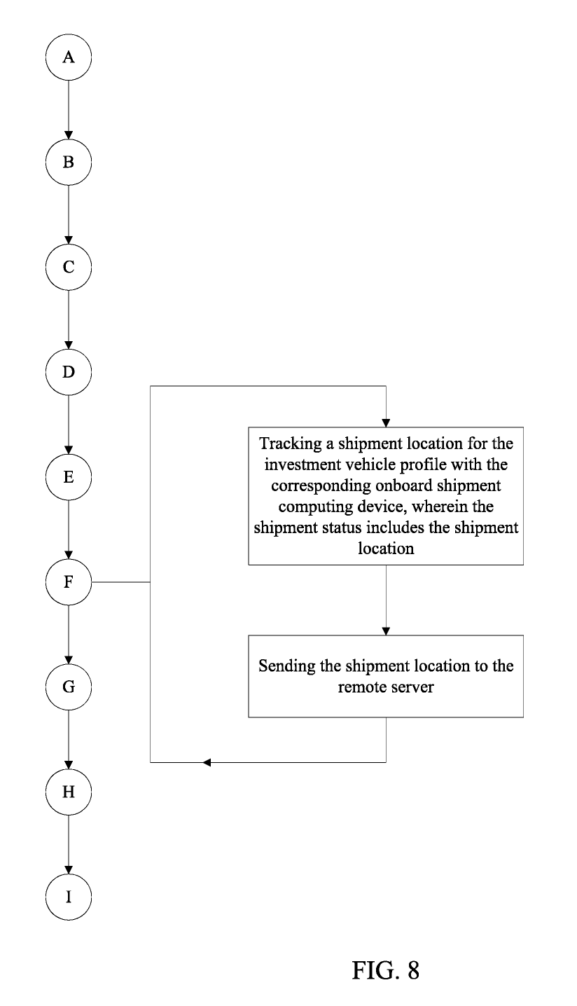

In reference to FIG. 8, regardless of whether the shipping distance is factored into the calculation of the investor payout, the location of a vehicle may be tracked by investors. This allows investors to monitor the progress on their investments and may be used when determining whether to pursue future investments. In order for investors to monitor a shipment, the corresponding onboard shipment computing device tracks a shipment location for the investment vehicle profile, wherein the shipment status includes the shipment location. The shipment location is sent to the remote server where it may be accessed by the investor.

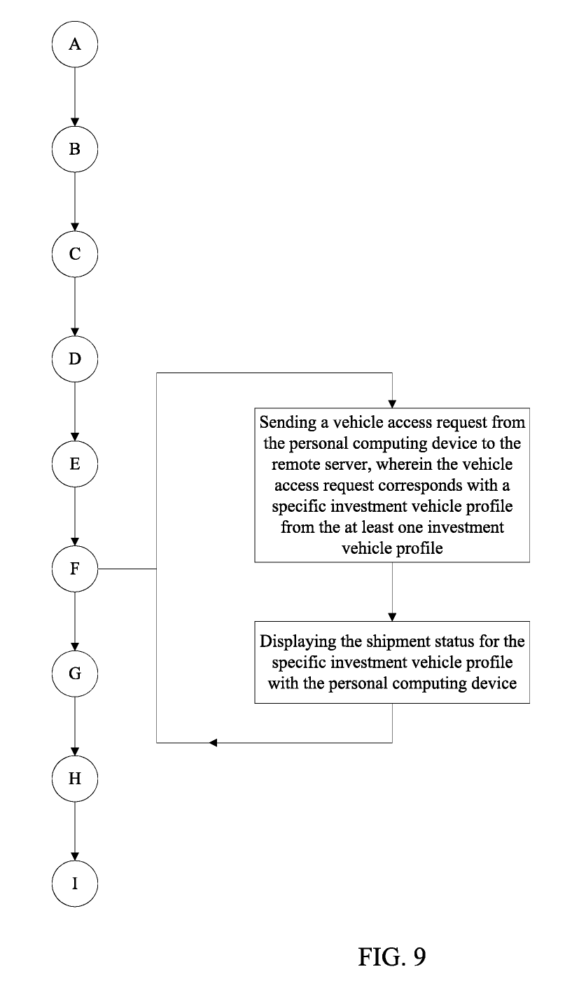

In reference to FIG. 9, for an investor to access the shipment location or the shipment status, in general, the personal computing device sends a vehicle access request to the remote server. The vehicle access request corresponds with a specific investment vehicle profile from the at least one investment vehicle profile. The personal computing device displays the shipment status for the specific investment vehicle profile. The shipment status may be periodically updated or may be updated in real time.

Although the invention has been explained in relation to its preferred embodiment, it is to be understood that many other possible modifications and variations can be made without departing from the spirit and scope of the invention as hereinafter claimed.

What is claimed is:

1. A method of managing cargo investments and tracking shipments, the method comprises the steps of:
(A) providing a personal computing device, at least one remote server, and a plurality of onboard shipment computing devices;
(B) managing an investor profile with the remote server, wherein the personal computing device is linked to the investor profile;
(C) managing a plurality of shipment vehicle profiles with the remote server, wherein each shipment vehicle profile is linked to a corresponding onboard shipment computing device from the plurality of onboard shipment computing devices;
(D) executing a negotiation process for the investor profile with the remote server in order to generate an investment contract;
(E) assigning the investor profile to at least one investment vehicle profile with the remote server, wherein the investment vehicle profile is from the plurality of shipment vehicle profiles;
(F) monitoring a shipment status for the investment vehicle profile with the corresponding onboard shipment computing device;
(G) receiving a shipping payment for the investment vehicle profile with the remote server, wherein the shipping payment corresponds to the shipping status;
(H) calculating an investor payout with the remote server, wherein the investor payout corresponds to the investment contract; and
(I) transferring the investor payout to the investor profile with the remote server.

2. The method of managing cargo investments and tracking shipments as claimed in claim 1 comprises:
providing a rate of return for the investment contract;
receiving a load ticket with the corresponding onboard shipment computing device, wherein the load ticket is included with the shipment status; and
extrapolating the investor payout with the remote server by comparing the rate of return with the load ticket.

3. The method of managing cargo investments and tracking shipments as claimed in claim 2 comprises:
wherein the load ticket comprises a shipment weight;
receiving the shipment weight with the corresponding onboard shipment computing device; and
multiplying the rate of return by the shipment weight in order to calculate the investor payout.

4. The method of managing cargo investments and tracking shipments as claimed in claim 2 comprises:
wherein the load ticket comprises a shipment distance;
tracking the shipment distance with the corresponding onboard shipment computing device; and
multiplying the rate of return by the shipment distance in order to calculate the investor payout.

5. The method of managing cargo investments and tracking shipments as claimed in claim 1 comprises:
providing a rate of return for the investment contract; and
multiplying the rate of return by the shipping payment after Step (G) in order to calculate the investor payout.

6. The method of managing cargo investments and tracking shipments as claimed in claim 1 comprises:
calculating the shipping payment with the remote server, wherein the shipping payment corresponds to the shipment status; and
generating a shipment invoice for the shipping payment with the remote server.

7. The method of managing cargo investments and tracking shipments as claimed in claim 1 comprises:
tracking a shipment location for the investment vehicle profile with the corresponding onboard shipment computing device, wherein the shipment status includes the shipment location; and
sending the shipment location to the remote server.

8. The method of managing cargo investments and tracking shipments as claimed in claim 1 comprises:
sending a vehicle access request from the personal computing device to the remote server, wherein the vehicle access request corresponds with a specific investment vehicle profile from the at least one investment vehicle profile; and
displaying the shipment status for the specific investment vehicle profile with the personal computing device.

9. The method of managing cargo investments and tracking shipments as claimed in claim 1 comprises:
receiving a potential investment amount with the remote server through the personal computing device;
generating a set of contract terms based on the potential investment amount with the remote server; and
compiling the set of contract terms into the investment contract with the remote server.
